(19) United States
(12) Patent Application Publication
(10) Pub. No.: US 2003/0083928 A1
(43) Pub. Date: May 1, 2003

(54) Pay and display parking machine with parking citation payment

(76) Inventor: George MacKay, Glasgow (CA)

Correspondence Address: Norman P. Soloway, HAYES SOLOWAY P.C., 130 W. Cushing Street, Tucson, AZ, 85701, US

(21) Appl. No.: 10/279,513

(22) Filed: Oct. 24, 2002

Related U.S. Application Data
(60) Provisional application No. 60/330,648, filed on Oct. 26, 2001.

(51) Int. Cl. G06F 17/60

(52) U.S. Cl. 705/13

(57) ABSTRACT

A citation system and method having a central computer processor for processing and storing citation data, a device for issuing citations, and pay and display parking machines for receiving parking payments and citation payments, wherein the citation information from the citation issuing device is transferred to the central computer processor and the citation payment information from the pay and display parking machines is transferred to the central computer processor to be reconciled with the citation information. The pay and display parking machine includes a computer processor for controlling the parking machine. The processor generates a display menu having a parking citation selection and further screens to receive citation information such as the citation identification number and the citation amount. The citation payments made to the parking machine may be parking citation payments.

This application claims the benefit of U.S. Provisional Patent Application Serial No. 60/330,648 filed on Oct. 26, 2001.

### FIELD OF THE INVENTION

The invention relates generally to the pay and display parking machines and more particularly to a system and method for making payment of parking citations at these machines.

### BACKGROUND OF THE INVENTION

A Pay and Display Parking Machine (P&DPM) is basically a “pay and display” or a “pay by space” machine which is a type of multi-space parking control device found in many cities of the world to control on-street or off-street (parking lot) parking spaces. It is usually much larger than a parking meter as it manages the payment and the acknowledgement of payment for many parking spaces. A typical P&DPM has a computer processor and a user interface that may include a graphic display, a keypad and/or control buttons. The P&DPM may also include a payment by credit card, cash and/or smart card facility, a coin return, a printer for receipt and ticket issue, a cash vault, a solar panel for powering the machine, advanced communications/on-line facilities, a data storage unit, advanced rate structure control, and advanced software features for controlling all of above. However, when motorists receive a parking or other citation, they find it necessary to pay the fine either through the mail or in person at some parking authority office, even though the citation often occurs in a parking facility served by a P&DPM. This results in frustration on the part of the motorist who is forced to waste time and possibly even lose revenue.

Therefore, there is a need for a method and system for making payment for parking citations through readily available pay and display parking machines.

### SUMMARY OF THE INVENTION

The invention is directed to a method of making a payment amount for a citation having an identification number through a pay and display parking machine. The method comprises activating the play and display parking machine display menu, selecting citation from the display menu, entering the citation identification number and paying the citation amount to the pay and display parking machine. The method may further include entering the citation fine amount into the pay and display parking machine.

In accordance with a further aspect of the invention, a pay and display parking machine for receiving a payment amount for a citation having an identification number comprises means for activating the parking machine display menu, means for providing a citation selection on the display menu, means for entering the citation identification number and means for receiving payment for the citation amount. The pay and display parking machine may further include means for entering the citation payment amount.

In accordance with another aspect of the invention, a system for making citation payments comprises a central computer processor for processing and storing citation data and a pay and display parking machine having a computer processor for controlling the machine to receive payments wherein the pay and display computer processor is programmed to receive citation payments. The processor may further generate a display menu that includes a citation payment option, and screens requesting citation information, such as a citation identification number and/or the amount of the citation payment.

In accordance with a further aspect of this invention, a method of operating a parking citation system having a central computer processor for processing and storing citation data and pay and display parking machines for receiving parking and citation payments, comprises issuing citations for parking violations, entering parking citation information into the central processor, having parking citation payments made at pay and display machines and transferring parking citation payment information from the pay and display parking machines to the central processor to be reconciled with the parking citation information.

In accordance with a further aspect of this invention, a parking citation system comprises a computer processor for processing and storing citation data, a device for issuing parking citations, means for entering the parking citation information from the citation issuing device into the computer processor, pay and display parking machines for receiving parking and citation payments and means for transferring parking citation payment information from the pay and display parking machines to the computer processor to be reconciled with the parking citation information.

### BRIEF DESCRIPTION OF THE DRAWINGS

The invention will be described with reference to the accompanying drawings, wherein:

FIG. 1 is schematic diagram of a citation system;

FIG. 2 is a block diagram of a P&DPM; and

FIGS. 3 to 6 illustrate screens generated by the P&DPM processor.

### DETAILED DESCRIPTION OF THE INVENTION

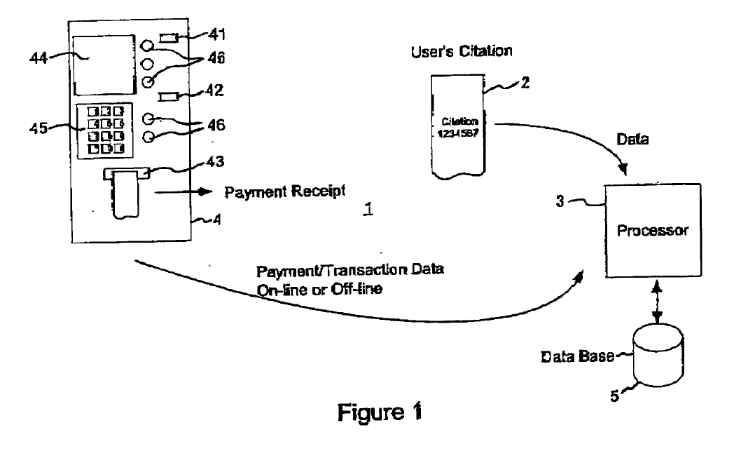

A citation system 1, as illustrated schematically in FIG. 1, generally consists of a central processor 3, which stores citation information in a data storage unit 5. The citation information found on the user's citation 2 may be manually inputted into the processor 3 or electronically transferred to the processor 3 if the traffic officer is utilizing an electronic citation unit (not shown). In the latter case, the citation information may be entered into the processor 3 and stored in the unit 5 almost instantaneously if the citation unit includes wireless communications.

Presently, the user is then required to go to some central location, such as the parking authority offices, to pay the fine associated with the citation. When the fine is paid, this information is also sent to the central processor 3 where it is reconciled with the information in the specific user's violation file in the database 5 to show that the fine has been paid and to preclude any further action against the cited user.

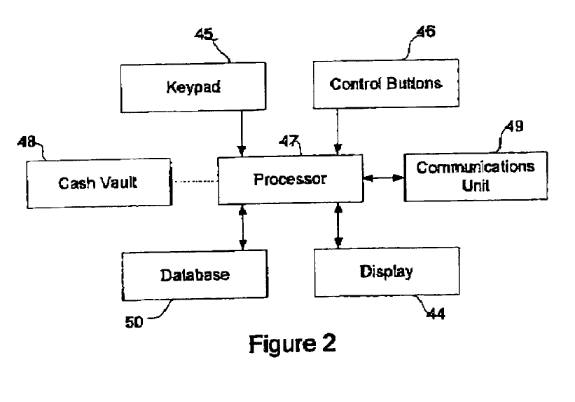

In accordance with the present invention, a P&DPM 4 of the type described above is incorporated into the citation system to provide the user a further option for the payment of citations. P&DPM 4 includes a payment slot 41 for credit cards, smart cards and/or cash, a coin return 42, a printer 43 for receipt and ticket issue, a graphic display 44, a numerical keypad 45 and a number of control buttons 46 for the user to interact with P&DPM 4. As shown schematically in FIG. 2, internally, the P&DPM 4 includes a processor 47 with advanced software features for controlling the P&DPM 4, a cash vault 48 for storing cash payments, advanced communications/on-line facilities 49 and a data storage unit 50. The P&DPM 4 may be powered by a conventional power connection, batteries and/or a solar panel (not shown).

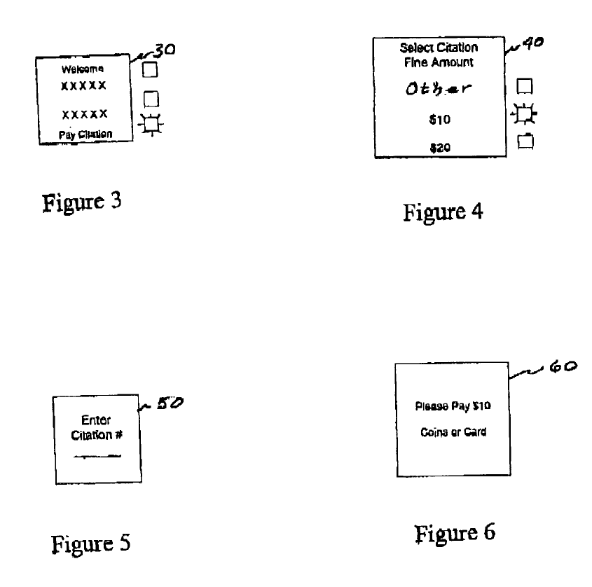

In accordance with the present invention, the processor 47 in the P&DPM 4 is programmed to display a number of screens on display 44 related to the citation payment process. The first screen 30, as illustrated in FIG. 3, provides the user a number of “payment type” choices. The next screen 40, as shown in FIG. 4, includes a number of the most common fine amounts as well as an “other” selection. The next screen 50, shown on FIG. 5, requests the citation number. The final screen 60, shown in FIG. 6 directs the user to pay the pre-entered amount of the fine.

In operation, the user approaches the P&DPM 4 and presses a user button 46 or a key 45 that activates the display menu 30 (FIG. 3), and then the user selects the option to “Pay Citation”. This prompts the next screen 40 on which the user is requested to select the amount of the citation fine that is to be paid. If the amount of the fine is not among the possible selections, the user selects “other” and then using the keypad 45, keys in the amount of the fine. Once the amount is entered, the next screen 50 (FIG. 5) prompts the user to key in the citation number. It is within the scope of the present invention to reverse the screens 40 and 50 whereby user would be requested to enter the citation number before the fine amount. The next screen 60 asks the user to make payment of the fine amount, which had been previously entered by the user, in whatever way that the particular P&DPM 4 is capable of accepting, which may include cash, credit card, smart card, debit card or other. The P&DPM 4 printer 43 then issues a receipt which is kept by the user as evidence of payment should they be challenged for non-payment in the future.

The record of payments data is forwarded to the central processor 3 where the citation payments are reconciled with the actual citations issued. In view of this, there is no requirement to physically deposit the parking ticket in the P&DPM 4.

In this manner, payment of a parking violation, for instance, may be paid right at the machine where a violation occurred making reference to the parking ticket ID marked on the ticket and perhaps as well as the user's license plate which is usually marked on the ticket as well. P&DPM's are normally capable of accepting payments for parking time in reference to a parking space. When the user receives a ticket for a violation, he will go directly to the P&DPM 4 to make payment for the citation rather than travel downtown to city hall or send the payment through the mail, usually at a higher cost after 7 days. As described above, the P&DPM 4 may also have the facility of allowing the payment information to be collected remotely using a modem or on-line connection 49. If the machine does not have an on-line connection 49, the parking authority is required to collect the data from the P&DPM 4 in a regular and timely fashion for the system to be effective.

While the invention has been described according to what is presently considered to be the most practical and preferred embodiment, it must be understood that the invention is not limited to the disclosed embodiment. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. A method of making a payment amount for a citation having an identification number through a pay and display parking machine comprising:
a. activating the pay and display parking machine display menu;
b. selecting citation from the display menu;
c. entering the citation identification number; and
d. paying the citation amount to the pay and display parking machine.

2. A method of making a citation payment as claimed in claim 1 further comprising entering the citation payment amount into the pay and display parking machine after step b.

3. A method of making a citation payment as claimed in claim 1 further comprising entering the citation payment amount into the pay and display parking machine after step c.

4. A method of making a citation payment as claimed in claim 1 further comprising:
e. receiving a receipt from the pay and display parking machine.

5. A pay and display parking machine for receiving a payment amount for a citation having an identification number, comprising:
means for activating the pay and display parking machine display menu;
means for providing a citation selection on the display menu;
means for entering the citation identification number; and
means for receiving payment for the citation amount.

6. A pay and display parking machine for receiving a citation payment as claimed in claim 5 which further comprises means for entering the citation payment amount.

7. A pay and display parking machine for receiving a citation payment as claimed in claim 5 further comprising means for providing a receipt for the received payment.

8. A system for making citation payments comprising:
a central computer processor for processing and storing citation data; and
a pay and display parking machine having a computer processor for controlling the machine to receive payments whereby the pay and display parking machine computer processor is programmed to receive citation payments.

9. A system for making citation payments as claimed in claim 8 wherein the processor generates a display menu that includes a citation payment option, and the processor further generates screens requesting citation information.

10. A system for making citation payments as claimed in claim 9 wherein the citation information comprises a citation identification number.

11. A system for making citation payments as claimed in claim 10 wherein the citation information comprises an amount for the citation payment.

12. A method of operating a parking citation system having a central computer processor for processing and storing citation data and a pay and display parking machine for receiving parking and citation payments comprising:
a. issuing citations for parking violations;
b. entering citation information into the central processor;
c. having citation payments made at the pay and display parking machines; and
d. transferring citation payment information from the pay and display parking machines to the central processor to be reconciled with the citation information.

13. A parking citation system comprising:
a computer processor for processing and storing citation data;
means for issuing parking citations;
means for transferring the citation information from the citation issuing means to the computer processor;
pay and display parking machines for receiving parking payments;
means for receiving parking citation payments at the pay and display machines; and
means for transferring parking citation payment information from the pay and display parking machines to the computer processor to be reconciled with the parking citation information.
